(19) United States
(12) Patent Application Publication
(10) Pub. No.: US 2009/0037967 A1
(43) Pub. Date: Feb. 5, 2009

(54) Video upload system

(76) Inventors: Oren Barkan, Tel Aviv (IL); Eyal Barkan, Tel Aviv (IL)

Correspondence Address: EMPK & Shiloh, LLP;c/o Landon IP, Inc., 1700 Diagonal Road, Suite 450, Alexandria, VA, 22314, US

(21) Appl. No.: 12/219,877

(22) Filed: Jul. 30, 2008

Related U.S. Application Data
(60) Provisional application No. 60/935,225, filed on Aug. 1, 2007.

(51) Int. Cl. H04N 7/173

(52) U.S. Cl. 725/105

(57) ABSTRACT

A video upload system comprising a web server adapted to receive, from a user, a video file and a selection of a plurality of video sharing websites; and a video upload engine adapted to log in to said plurality of video sharing websites and to upload said video to said plurality of video sharing websites, based on the selection received from said user.

### CROSS-REFERENCE TO RELATED APPLICATIONS

This application claims the benefit of U.S. Provisional Patent Application No. 60/935,225, entitled “System and Method for Uploading Video Information to Multiple Targets”, filed Aug. 1, 2007, incorporated herein by reference in its entirety.

### FIELD OF THE DISCLOSURE

Embodiments of the disclosure relate to uploading of video to multiple targets.

### BACKGROUND

The Internet has enabled computer users all over the world to interact and communicate electronically. One particularly popular mode for communication is through Web pages, which collectively form the World Wide Web. Web pages are useful for displaying text and graphics, and even animation, video data and audio data.

Popular video sharing Web sites such as YouTube, MetaCafe and the like, enable users to upload video content for sharing with viewers through the Internet. Such users may be individuals who create video content as amateurs. Sometimes, amateur video content creators may be paid by the Web site, for example, by sharing of advertising revenues generated by the Web site when viewers choose to view a particular video and at the same time are provided with advertisement(s) to watch. This market is currently small but growing, and may provide an opportunity for amateur video content creators to earn revenues from their video content.

Users may also be corporations and/or advertising agencies who attempt to create “viral” advertisements. A “viral” advertisement is often defined as one which is viewed voluntarily by viewers, rather than being imposed on viewers who wish to watch something else (as in the example of television programs). Some highly successful viral advertisements have caused viewers to even search for locations on the Internet to download and view the advertisement, thus providing virtually free publicity to their creators.

Thus, whether from amateur video content creators or from professional advertising companies (or other corporations or organizations), video content sharing websites are receiving increasing amounts of such video content for display.

### SUMMARY

There is provided, in accordance with an embodiment, a video upload system comprising a web server adapted to receive, from a user, a video file and a selection of a plurality of video sharing websites; and a video upload engine adapted to log in to said plurality of video sharing websites and to upload said video to said plurality of video sharing websites, based on the selection received from said user.

In some embodiments, said web server is further adapted to identify the user.

In some embodiments, said video upload engine is further adapted to select a best performing server of at least one of said plurality of video sharing websites, and wherein said upload is performed to said best performing server.

In some embodiments, the video upload system is further adapted to fetch statistical information pertaining to said video file from at least one of said plurality of video sharing websites.

In some embodiments, said web server is further adapted to alert said user if said video file is determined to be a previously uploaded video file.

In some embodiments, said web server is further adapted to prevent the upload of said video file if said video file is determined to be a previously uploaded video file.

In some embodiments, the video upload system further comprises a scheduler adapted to schedule said upload of the video file to at least one of said plurality of video sharing websites.

In some embodiments, the video upload system further comprises a scheduler adapted to schedule a removal of said video file from at least one of said plurality of video sharing websites.

In some embodiments, the video upload system further comprises a recommendation module adapted to provide said user with a recommendation of one or more video sharing websites suitable for the video file.

In some embodiments, the video upload system further comprises an account monitoring module adapted to monitor information pertaining to an account of said user.

In some embodiments, the video upload system further comprises a payment module adapted to collect payment from said user.

In some embodiments, said log in comprises a log in using an account selected from a group consisting of: an account registered by said video upload system on behalf of said user, an account registered by said user, and a generic account associated with said video upload system.

There is further provided, in accordance with an embodiment, a method for uploading a video, the method comprising receiving, from a user, a video file and a selection of a plurality of video sharing websites; logging in to the plurality of video sharing websites; and uploading the video to the plurality of video sharing websites, based on the selection received from the user.

In some embodiments, the method further comprises identifying the user.

In some embodiments, the method further comprises selecting a best performing server of at least one of the plurality of video sharing websites, and wherein said upload is performed to said best performing server.

In some embodiments, the method further comprises fetching statistical information pertaining to the video file from at least one of the plurality of video sharing websites.

In some embodiments, the method further comprises alerting the user if the video file is determined to be a previously uploaded video file.

In some embodiments, the method further comprises preventing the upload of the video file if the video file is determined to be a previously uploaded video file.

In some embodiments, the method further comprises scheduling the upload of the video file to at least one of the plurality of video sharing websites

In some embodiments, the method further comprises scheduling a removal of the video file from at least one of the plurality of video sharing websites.

In some embodiments, the method further comprises providing the user with a recommendation of one or more video sharing websites suitable for the video file.

In some embodiments, the method further comprises monitoring information pertaining to an account of the user.

In some embodiments, the method further comprises collecting payment from the user.

In some embodiments, the logging in comprises logging in using an account selected from a group consisting of: an account registered by said video upload system on behalf of said user, an account registered by said user, and a generic account associated with said video upload system.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. It is intended that the embodiments and figures disclosed herein are to be considered illustrative rather than restrictive. The figures are listed below.

FIG. 1 shows a flowchart of a method for uploading video content to a plurality of targets;

FIG. 2 shows a flowchart of a method for transfer of one or more files to one or more targets;

FIG. 3 shows a flowchart of a method for selecting one or more targets;

FIG. 4 shows a flowchart of an upload process;

FIG. 5 shows a flowchart of a method for user login;

FIG. 6 shows a flowchart of a method for obtaining data about a video;

FIG. 7 shows a flowchart of a method for scheduling video content;

FIG. 8 shows a network diagram of video upload to multiple targets; and

FIG. 9 shows a block diagram of a system.

### DETAILED DESCRIPTION

An aspect of some embodiments of the disclosure relates to a system and method for uploading video content through a network to a plurality of targets. A user may upload such video content essentially once, after which it may be distributed to the plurality of targets.

The system may include a video receiving module, which receives one or more videos uploaded by a user, as well as a selection made by the user as to the targets to which he or she desire to distribute the video to. The receiving module may be a web server or be embodied in a web server. A video upload engine may then upload the received one or more videos to a plurality of targets. The receiving module and/or the video upload engine may be embodied in a server or a plurality of servers, such as in a web server.

In an embodiment, the plurality of targets comprises video sharing websites. By “video sharing website” it is meant any website, blog and/or the like which hosts video content and/or which can provide, share or broadcast video content, whether for public viewing or for individualized, restricted (for example after payment) and/or subscription-based viewing. The network optionally comprises the Internet, but may be any essentially computerized network such as a Local Area Network (LAN), a Wide Area Network (WAN), a Wireless Area Network (WiLAN), a Wireless Fidelity (WiFi) network, a Worldwide Interoperability for Microwave Access (WiMAX) network, a cellular network and/or the like. Each such website may optionally comprise a server or a plurality of servers to which the video content is uploaded, such as by a video upload engine according to the present disclosure. The video content is, therefore, optionally “pushed” to all target locations (such as a plurality of servers). The video content may then be displayed on-line to one or more viewers.

The user may optionally be any person, company, corporation or organization who wishes to upload video content. Such video content may optionally comprise any type of video, including but not limited to, amateur video content, professionally produced video content and/or advertisement video content.

In an embodiment, the system and method may perform any necessary registration process(es), if any are required, on behalf of the user whose video content is being uploaded to the targets. Optionally, the system and method of the present disclosure save the registration information. Optionally, the system and method of the present disclosure monitor the uploading and display process at each target by using the registration information to “log in” to the target and so to obtain the information, which may then be displayed to the user.

Optionally, the system may log in to each of the targets using one or more generic accounts that were previously registered for use by the system. For example, accounts may be opened at the desired targets by the system (automatically) and/or by an administrator (manually), and the credentials (such as a username and a password) for these accounts may be supplied to the system. The system may then be able to upload one or more videos received from the user, using one or more of these generic accounts associated with the system. Use of such generic accounts may spare the need for the user to supply the system with his own account details at the targets, and/or may save time and resources for the system itself by skipping the stage of registering a new account for each user requesting an upload. Optionally, the user may be allowed to choose whether to supply his existing target account information, to have the system register an account on his behalf, or have the system use one or more of its generic accounts.

Non-limiting examples of video formats suitable for operation with the present invention include MPEG and its variants, QuickTime, M-JPEG, AVI, 3GP, WMV, flash and the like.

Implementation of the method and system of the present invention involves performing or completing certain selected tasks or stages manually, automatically, or a combination thereof. Moreover, according to actual instrumentation and equipment of embodiments of the method and system, several selected stages may be implemented by hardware or by software on any operating system of any firmware or a combination thereof. For example, as hardware, selected stages of the invention may be implemented as a chip or a circuit. As software, selected stages of the invention may be implemented as a plurality of software instructions being executed by a computer using any suitable operating system. In any case, selected stages of the method and system of the invention may be described as being performed by a data processor, such as a computing platform for executing a plurality of instructions.

Although the present method and system are described with regard to a “computer” on a “computer network”, it should be noted that, optionally, any device featuring a data processor and/or the ability to execute one or more instructions may be described as a computer, including, but not limited to, a PC (personal computer), a server, a minicomputer, a cellular telephone, a smart phone, a PDA (personal data assistant), a pager, a TV decoder, a game console, a portable media player, an ATM (automatic teller machine), a POS (point of sale) credit card terminal, an electronic cash register and/or the like. Any two or more of such devices in communication with each other, and/or any computer in communication with any other computer, may optionally comprise a “computer network”.

By “online” it is meant that communication is performed through an electronic communication medium, including but not limited to, communication through cellular telephones; exchanging information through Web pages according to HTTP (HyperText Transfer Protocol) or any other protocol for communication with and through mark-up language documents; exchanging messages through e-mail (electronic mail), messaging services such as, for example, ICQ, and/or any other type of messaging service; any type of communication using a computational device as previously defined; as well as any other type of communication which incorporates an electronic medium for transmission.

The terms “statistics” or “statistical information”, as referred to herein in regard to a video, may relate to any information pertaining to viewers of the video, such as a number of viewers, a number of comments left by viewers, demographic and/or geographic characteristics of the users, and/or any other information associated with the viewers. In addition, the terms may relate to a number of times the video was shared by viewers with their acquaintances.

According to an embodiment, the user may be able to monitor account information regarding the video content, including but not limited to information such as where the video content has been uploaded, where the user has been registered, analysis and statistics about the number of displays of the content (optionally including any added value analysis, such as a comparison of viewing statistics between video content sharing websites), whether the video content is being shown (optionally including all available information about the video content, including but not limited to comments, reviews and the like). The monitoring of the account information may be enabled by an account monitoring module. Optionally, the user may also indicate whether a “share” function is to be performed, such as, for example, sending email to specific individuals and/or to a group, and/or by sending the URL (Internet address) directly to specific individuals and/or groups, for example from the video sharing website. This message may also optionally be sent from the video upload engine and/or from the server (and/or other sharing functions may also optionally be performed from the system).

The account information may include whether there have been any problems with uploading the video content, including any type of rejection of the content. The account information may also include revenue and/or payment information from the video sharing website. Monitoring is optionally web-based although, optionally, it may be downloaded to the user's computer.

According to an embodiment, the video content is uploaded from the computer of the user through software which may optionally be “Web based” software (meaning, provided by a web server through the Internet and/or through SaaS (software as service) and/or through a plug-in to a Web browser or any other Web browser based mechanism), but which, alternatively, may feature at least a portion of the software being installed on the computer of the user. The system and method of the present disclosure (for example through the video upload engine) may check to see whether the same file has already been uploaded from the computer of the user. The video upload engine is optionally able to cancel the uploading process, for example upon request by the user.

Optionally, a pre-uploading process is performed to determine whether a particular unit of video content (such as a particular file, for example), was already uploaded, such as by featuring an examination of the size of the file before uploading it to the system. During and/or after uploading, the video upload engine may examine the name of the file and/or the checksum of the file to determine whether the user has already uploaded it. If the name and/or checksum are identical, then the user may be informed that the same file has already been uploaded.

According to an embodiment, the system and method may remove the video content from a web site or all web sites (and/or other targets), optionally in response to a request by the user. The user is also optionally able to determine a time limit for displaying the video content, for example up to a certain date and/or between specific dates, such that the video upload engine, according to the present disclosure, optionally provides the video content to the targets during the specified time period and then causes the video content to be removed after the specified time period has elapsed.

Such determination of an appropriate time period is optionally performed with a scheduler, for receiving user input regarding the time period and for executing removal of the video content after the time period has expired (optionally also for causing the video content to be uploaded at the start of the time period). The user may optionally specify such time delimited availability of the video content at a target at the initiation of the upload process and/or after the video content has been uploaded. The user may optionally also initially request a certain time delimited period but then adjust such a period after video content has been uploaded. By “time delimited” it is meant according to a particular period of time (from a particular date (and/or day/time) to a particular date (and/or day/time), and/or according to elapsed time) and/or according to a particular threshold of pre-determined “views” of the video sharing content, with or without a direct tie to a particular day/time.

According to an embodiment, a plurality of different files, packages and/or other units of video content may optionally be uploaded from the computer of the user through a single request and/or simultaneously or substantially simultaneously.

According to an embodiment, there is provided a payment mechanism and/or module, optionally operating in a PPU (pay per upload) manner, adapted to collect payment from the user for the use of the system and method of the present disclosure for uploading video content to one or more targets. Additionally or alternatively, the payment mechanism/module may operate in a PPV (pay per view) and/or PPC (pay per click) manner, and be adapted to collect payment from the user respective to the number of times his video was viewed and/or clicked in the video sharing websites to which it was uploaded, and/or in third-party websites embedding this video. In this PPV/PPC mode of operation, the user may be charged based on the actual performance of his video, which may be advantageously measured by the reach of the video, namely, the amount of people who watched it. PPV/PPC mode may be appreciated, for example, by commercial users and/or advertising agency users, who often measure promotional campaigns according to the amount of people who were exposed to it.

According to an embodiment, the video upload engine is further adapted to select a best target or targets for uploading the video content. For example, the video upload engine may optionally select the best performing server(s) associated with the target(s) for uploading the content according to available bandwidth and/or current load. The video upload engine is optionally able to check the current load according to the IP address for each server at each location. For example, such information may optionally be obtained from Internet Control Message Protocol (ICMP) traffic reports by using ICMP packets. The video upload engine may also optionally select one or more servers for future use according to their network response time, after sending content to a server.

According to an embodiment, the user may optionally request viewing statistics (and/or other statistics) for a plurality of videos, for example, from a single video content provider and/or grouped according to some other characteristic, such as video content which is related to a particular advertising campaign, or a combination thereof. Optionally the user may specify a plurality of filtering parameters according to which the statistical information is to be displayed. The statistical information may also optionally include information with regard to the number of times that the video content was “shared” (for example, through an e-mail sent from the video sharing site and/or other sharing mechanism), the number and/or content and/or type of comments received on the video sharing site about the video content (if available), and so forth. The statistical information may also optionally be filtered according to time of day, date, whether viewer numbers are increasing or decreasing, demographic information (if available) and any other type of correlation.

The statistics may be provided by the video upload engine, which may be adapted to connect to at least one of the targets and fetch statistical information pertaining to one or more videos.

Optionally, statistical information pertaining to one or more videos may be fetched from at least one third-party website embedding the video(s). Video sharing websites often enable the display of their hosted videos on other, third-party websites. The display is sometimes performed by embedding the video in the third-party website, in such a way that the video may be played directly from the third-party website. Sometimes, the video is still hosted by the video sharing website, although to a user visiting such a third-party website, the embedded video may appear as if it is part of the website, when in fact it is transparently played from its source at the original video sharing website. In other scenarios, the video may be physically copied to the third-party website and hosted essentially therein.

Therefore, fetching statistical information as to the video from the video sharing website itself may not reveal the true number of views, comments and/or the like the video has overall received. The system may thus be able to fetch the statistical information also from third-party websites embedding the video, so that the user who uploaded the video may be presented with broader statistics pertaining to his video's performance in various websites. The system may also be able to provide the user with information as to the identity (name, URL and/or the like) of the third-party websites embedding the video, whether with or without the statistics-since some third-party websites do not offer statistics. The term “third-party website”, as referred to herein, may refer to any website that embeds a video file that was previously received from a user by the system of the present disclosure, whether the website hosts a copy of the video or plays it from the video sharing website.

The fetching of statistical information from third-party websites may be performed, for example, by matching an identifier of the video used by a video sharing website to an identifier used by the third-party website embedding the video. Video sharing websites often designate each hosted video with a unique identifier, commonly a combination of letters and/or numbers. This identifier usually exists in a code of the third-party website embedding the video, in order to allow playing of that video from its source at the video sharing website. The system of the present disclosure may crawl the web, optionally focusing on websites determined by an administrator to be more prone to video embedding, and look for identifiers of embedded videos. If an identifier of a video embedded on such a third-party website matches that of a video previously uploaded by a user of the system, statistics pertaining to views, comments and/or the like of the video may be fetched from those third-party websites and presented to the user.

As another example, the system may match a fingerprint of a previously uploaded video with a fingerprint found in a video embedded in a third-party website. Video fingerprinting is often defined as a technique for identifying characteristic components of a video, enabling that video to be uniquely identified by its resultant “fingerprint”. Video fingerprinting analysis may be based on any number of visual video features including, but not limited to, color and motion changes during a video sequence. Therefore, the system of the present disclosure may crawl the web and match fingerprints of videos on third-party websites to fingerprints of videos previously uploaded by a user of the system.

As yet another example, the system may place a unique digital watermark on an uploaded video, so that this video may later be identified if embedded in third-party websites. Digital watermarking is often defined as the process of embedding information into a digital video, so that if the video is copied, the information is also carried in the copy. In visible watermarking, the information is visible in the video. In invisible watermarking, information is added as digital data the video, but it cannot be easily perceived as such with the naked eye.

In a further example, the system may match parameters pertaining to the video uploaded by the user with parameters found on third-party websites. This parameters may be, for instance, the video's title, description, tags and/or any other text accompanying the video. Since it is likely that an embedded video will base similar or identical parameters as in the video sharing website that initially hosted it, matching these parameters may allow determining, with essentially high reliability, if the video found on a third-party website is the same one that was previously uploaded to the system by a user. Optionally, the system composes a “reliability measure” being a computed likelihood that the found video is the one that was previously uploaded by the user. The computation may include determining the percentage of parameters appearing on the third-party website which are also used on the video sharing website, although other computation methods are also intended herein.

According to an embodiment, the system may include a recommendation module adapted to provide the user with a recommendation of one or more targets suitable for the video. The recommendation is provided before, during and/or after the upload of the video by the user to the system.

The term “suitable”, in regard to the targets, may relate to a target which already contains a substantial amount of other videos of a genre, style and/or other characteristics similar to those of the user's video. Alternatively, “suitable” may relate to a target which declares that its purpose is to host videos of a certain genre, style and/or videos having other characteristics.

Furthermore, the recommendation module may provide a recommendation of a suitable channel, category and/or sub-area (hereinafter a “group”) within a specific target. Some targets, such as, for example, the YouTube web site, divide videos into a plurality of groups, each being of a certain genre and/or targeting a certain audience.

The recommendation provided by the recommendation module may enable the user, whether an individual, a company, an advertising agency or the like, to intelligently distribute their video across multiple targets. For example, a humoristic viral advertisement may be more suitable for a humor-oriented target than for a target including mainly documentary videos. Distributing that viral advertisement to a documentary-oriented target may even, in some scenarios, create a negative effect for the user.

The recommendation module may make the recommendation by matching one or more parameters of the video, prior to or after upload, with one or more parameters of known targets. Known targets may be crawled by the recommendation module, either in response to a video upload request or on a regular basis, to extract one or more parameters pertaining to the targets. These parameters may be, for example, video titles, tags, descriptions, comments, group (channel, category and/or sub-area), popularity and/or any other data available at the target, either in the target's user interface and/or in the source code of this user interface.

The parameters pertaining to the targets may be statistically analyzed, to determine the significance of one or more of the parameters. For example, the significance of tags associated with a video on the target may be determined according to the popularity of the video and/or the amount of comments associated with the video.

The parameters found at the targets are matched to those of the user's video. Parameters of the user's video may be automatically and/or manually received. For example, the user may be requested to manually input information pertaining to the video, such as a title, description, tags, genre, category and/or the like. Automatic receipt of parameters may be performed by analysis of the video itself. Video analysis may include, for instance, determination of the video's thematic tempo, prominent colors, prominent objects (for example-humans, recognized by face recognition methods) and/or the like.

An example of parameter matching may be when the user's video is a home video showing pets, and the recommendation module may determine which target(s) include a statistically significant amount of parameters pertaining to home videos, pets, and/or related words, such as amateur videos, dogs, cats and/or the like. These targets may be recommended to the user.

The recommendation provided to the user by the recommendation module may have different formats. For example, a simple list of recommended targets may be displayed. As another example, a more detailed list may include recommended targets, along with a measure of suitability. This measure of suitability may be based on the matching of the video parameters with the target parameters. The matching may be, for example, weak, intermediate or strong-and this information may be displayed to the user. Optionally, the recommendation provided to the user may include information pertaining to the targets, such as demographic, geographic and/or any other association or orientation of the recommended targets. For example, a target may be presented to the user alongside text identifying the target as targeting mainly youth in the Unites States, so that the user may decide if this target audience is desired or not.

The principles and operation of the present disclosure may be better understood with reference to the figures and the accompanying description.

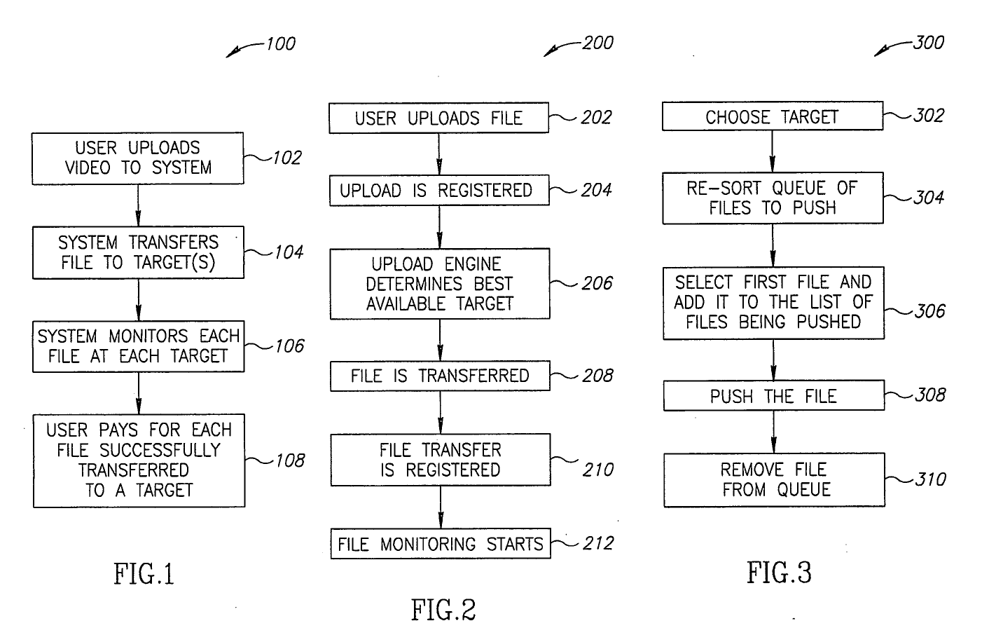

Referring now to the drawings, FIG. 1 shows a flowchart 100 of an exemplary, illustrative method for uploading video content to a plurality of targets, according to an embodiment. As shown, in a block 102, the user uploads video content, for example, in the form of a video file, to a system, such as using a video receiving module. The content may optionally be uploaded from any computer, as described herein, including but not limited to a personal computer, video camera and/or mobile telephone.

In a block 104, the video content (such as a file) is transferred to one or more target(s), such as to a plurality of targets. The transfer may be performed by a video upload engine being part of the system. Optionally, the video content is transmitted to a plurality of video content sharing websites through their respective servers.

In a block 106, the system may monitor each file at each target, for example, in order to make certain that the upload to each target was successful, but also, optionally, to monitor how many times the video content is being shown, and so forth. The monitoring may be performed by an account monitoring module of the system.

In a block 108, the user may pay for each file successfully transferred to a target. Optionally, the user may only pay for files which the target accepted and/or which were displayed (as in the non-limiting example of video sharing websites).

FIG. 2 shows a flowchart 200 of an exemplary, illustrative method regarding transfer of one or more files to one or more targets. As shown, in a block 202, the user uploads a file of video content to the system, as previously described. In a block 204, the upload is registered. Optionally, the user is required to register (for example, with the server) in order for the upload to be accepted. The user is optionally required to register once and optionally to provide payment details, for example, for the embodiment of FIG. 1, which optionally features payment for distributing the file to each target. The user may then optionally be required to log-in again each time at the system so as to be identified by the system, for example, by providing one or more identifying details such as a user name and password, for example. This registration may also enable the bandwidth and efficiency of the server to be best used.

In a block 206, the video upload engine optionally selects one or more best available target(s) to which the server is to provide the video content (such as the video file, for example). The video upload engine optionally monitors the targets, such as the server(s) of each video sharing website, in order to determine their network response speed. Priority is optionally given to servers with faster network response speeds. The video upload engine also optionally manages the queue of files to be transferred, including determining where and when to submit, depending upon traffic and network data. The video upload engine may optionally perform the transfer itself or may alternatively direct a server to perform the transfer. The video upload engine, optionally, also monitors the number of file views at a target (if, for example, the target is a video sharing website) as well as any comments or reviews, or other information provided about the video content once it has been uploaded to the target.

In a block 208, the file is transferred to the target. In a block 210, the transfer is registered if successful, and the user is optionally notified. Payment may also optionally be required at this point (as described with regard to FIG. 1). In a block 212, file monitoring is initiated by the video upload engine, as previously described.

FIG. 3 shows a flowchart 300 of an exemplary, illustrative method for selecting and/or determining one or more targets for pushing each file and for managing this process by the video upload engine in more detail. In a block 302, the video upload engine may choose the target, optionally by geographic location and/or according to target(s) having fewer concurrent uploads and with the best network response times.

In a block 304, the video upload engine re-sorts the queue of files to push to each target, for example, according to files which are more suited to a particular target and/or which have not been previously submitted to a currently available and responsive target.

In a block 306, the video upload engine selects the first file from the queue and adds it to a list of files that are being pushed now. In a block 308, the file is pushed, for example, by the video upload engine. In a block 310, the file is removed from the queue. The method may then be repeated for additional one or more files.

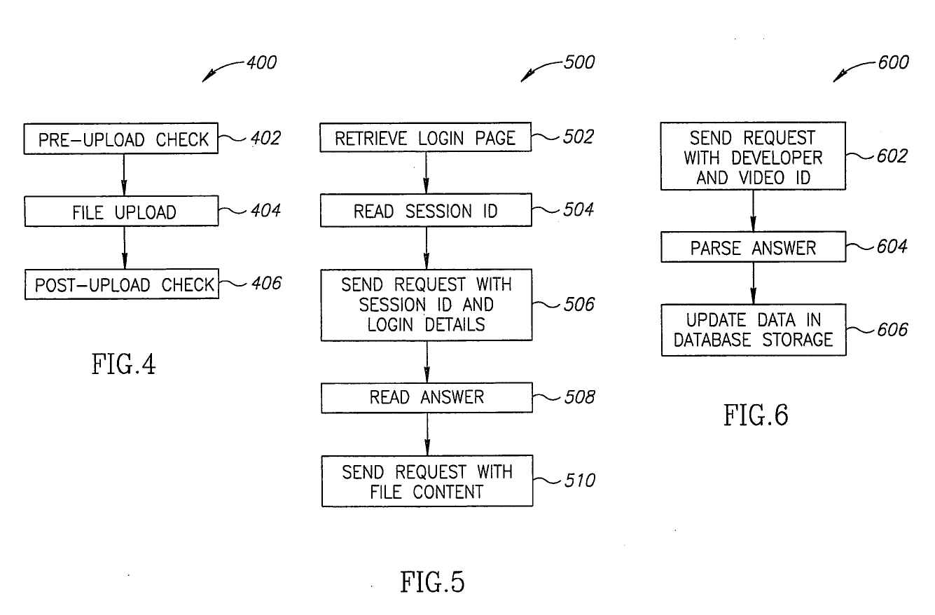

FIG. 4 shows a flowchart 400 of an exemplary, illustrative upload process in more detail, according to an embodiment. In a block 402, the system and/or video upload engine optionally performs a pre-upload check, according to the file name and size (and/or optionally other parameters). The video upload engine and/or system optionally warns the user if a file with the same or similar parameters was uploaded. The user may also optionally be blocked from uploading duplicated files.

Alternatively, upload of a file that was previously uploaded may be allowed. For example, such an upload may be allowed if, at the time of the upload, the system is aware of new targets which were not known at the time the same file was previously uploaded. That is, the system may be, occasionally, updated with identities of additional targets to which the distribution of video files is possible. A user may therefore be enabled to select these new targets for distribution, even if he previously uploaded the file to the system for distribution to other, formerly-known targets. Optionally, if such a case occurs, the system may be able to upload the previously uploaded video to the newly selected targets, without requiring the user to upload the file again.

As another example, a user may be allowed to upload a previously-uploaded video if the distribution of the video has previously failed-at least in regard to one of the selected targets. The user may therefore be able to retry the upload of the video, so that the video is uploaded to the target(s) to which an upload previously failed. Optionally, if such a case occurs, the system may be able to upload the previously uploaded video to the target(s) to which an upload previously failed without requiring the user to upload the file again.

In a block 404, the file is uploaded, as previously described. In a block 406, the video upload engine and/or system optionally calculates the checksum for each file after it is uploaded; if there is already a file with the same checksum, the user is optionally warned about duplicate content. The duplicated file may also optionally be blocked. Other parameters may also optionally be checked after uploading.

FIG. 5 shows a flowchart 500 of an exemplary, illustrative method for user login and uploading.

In a block 502, a login page is retrieved responsive to the user requesting the login page. A session is started in a block 504, once the page has been provided. The session optionally includes a session identifier which is to be associated with the user.

In a block 506, the user fills in the information, as necessary, with regard to any type of user identification (such as user name and password). As a non-limiting example, the data may optionally be submitted via an HTTP GET or POST method. The video upload engine and/or system then receives this information and identifies the user, in a block 508. If the information matches a known user, then the session is matched to the user and the upload process may begin, in a block 510. For example, the video content may optionally be uploaded as a file through the POST command, as discussed with regard to block 506.

FIG. 6 shows a flowchart 600 of an exemplary, illustrative method for obtaining data about a particular video from a video sharing website. In a block 602, the video upload engine sends a request with developer and video ID (identification) to a server or other portal at a video sharing website. Some video sharing websites, such as YouTube, for example, provide an API (application programming interface) or other type of interface, which allows such a request to be made without logging. into the server or portal. A non-limiting example of such a request, formatted according to YouTube, is as follows: http://www.youtube.com/api2_rest?method=youtube.videos .get_details&dev_id=dev_id&video_id=video_id. In this example, dev_id is the registered developer's (such as a video content creator and/or uploader) ID or identifier for YouTube. This identifier is received from the YouTube site when the developer registers. The video ID is the YouTube identifier for a specific video. This identifier is received after video content has been successfully uploaded.

In a block 604, an answer (regarding the request for data) is received from the video sharing website server or portal, and is parsed. The response may optionally 5 include specific requested information and/or general information, which is sent upon response to any request. For the non-limiting example of YouTube, the server responds with data in XML format with predefined field set, into which the data is placed. The response optionally includes information for a specific uploaded video file, such as the average rating by viewer(s), views count (the number of times that the video has been viewed) and received comments, if any.

In a block 606, the received and parsed data is optionally used to update local and/or other types of database(s), for example, in order to show the information to the user. The user may optionally request viewing statistics for a plurality of videos, for example, from a single video content provider, and/or grouped according to some other characteristic, such as video content which is related to a particular advertising campaign, or a combination thereof. Optionally, the user may specify a plurality of filtering parameters according to which the statistical information is to be displayed.

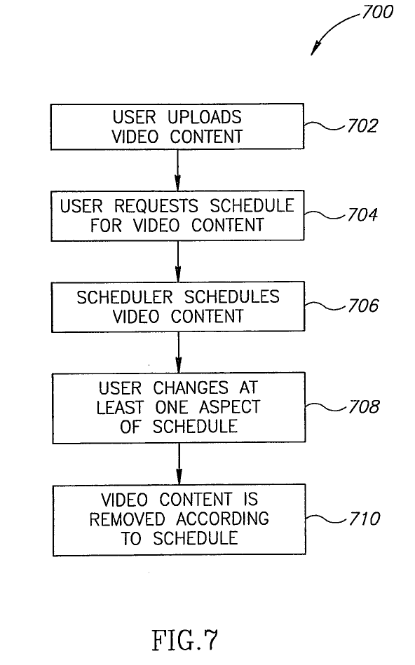

FIG. 7 shows a flowchart 700 of an exemplary, illustrative method for scheduling video content. As shown, in a block 702, the user uploads the video content to the system, as described herein.

In a block 704, before or after uploading such content, the user optionally requests a schedule for such content. Such a schedule optionally includes a time delimited period, which may optionally include a start and stop time. The start may optionally be “immediately” or alternatively a specific date (and/or date/time), while the stop time may optionally be a specific date (and/or date/time) or alternatively after a certain number of views have been achieved. The time delimited period may also optionally be related to at least one other uploaded video content, for example, enabling an advertiser to pre-schedule a “rolling campaign” in which a plurality of videos are optionally uploaded according to a time delimited sequence, so that they are essentially sequentially introduced to viewers. The term “essentially sequentially” may relate to sequential introduction and/or to introduction with a certain degree of overlap. As previously noted, “time delimited” may optionally relate to an absolute time (such as an absolute date/time), a relative time (for example, elapsed time) and/or “time” according to the number of views and/or some other video sharing related factor.

In a block 706, the scheduler determines when the video content may initially be displayed and when it is to be removed. Optionally, the user may specify only a start for the display but desire an unlimited display period.

In a block 708, the user may optionally change an aspect of the schedule after uploading the video content, even after the content has been sent to at least one target.

In a block 710, the scheduler optionally removes the video content, according to the schedule as determined by the user (or causes the video upload engine to remove such content), which may optionally be performed through the tool(s) available at each target for removing video content.

Some non-limiting examples of the above methods are provided below with regard to a particular video sharing website, known as “blip.tv”. These examples are provided for the purpose of illustrating the above embodiments and are not intended to be limiting in any way.

With regard to registering a user on a video sharing website, as noted above, the video upload engine (and/or another entity) may optionally be registered as for a user, in order to be able to upload video content to the video sharing website. In this case, the user is not required to register on a video sharing website; instead the video upload engine and/or another entity, according to the present invention, optionally performs the registration process, thereby creating a user account on behalf of the user, for later use in uploading video content. A non-limiting optional example of such a process is now described with regard to the requirements of blip.tv.

For registration to occur, the video upload engine and/or another entity sends a POST request. It should be noted that the password may be sent twice with different names according to the blip.tv server registration process; other registration processes may optionally be different (for example, sending only one password and/or more than two passwords). The server or other portal at the video sharing website, in this example, blip.tv, then replies with information that is checked for registration errors such as “login name already used”.

Once registered, the user may login to the video sharing website; however, for this example (and according to some embodiments) the video upload engine and/or other entity at the system of the present invention, optionally performs the login process in place of the user, in order to upload the video content.

The video upload engine and/or other entity sends a POST request. The video upload engine and/or other entity receives cookies from the response sent by the server and/or other portal at the video sharing website.

Before file upload may occur, the video upload engine and/or other entity receives the following URL http://blip.tv/file/post/ (with cookies) and retrieves cookie values from the page to which the URL points. These cookies are used in the file uploading process.

Uploading from the video upload engine and/or other entity at the system of the present invention is now optionally performed according to the above process with regard to this non-limiting example, and according to some embodiments of the present disclosure.

According to some embodiments, the user may optionally choose to use any one of the above tools after the video content has been uploaded to a target, such as a video sharing web site. For example, the user may optionally request automatic monitoring of statistics as described herein, by providing the necessary details about the previously uploaded video content to the video upload engine (or another entity), after which the video upload engine optionally performs the requested action(s) on behalf of the user.

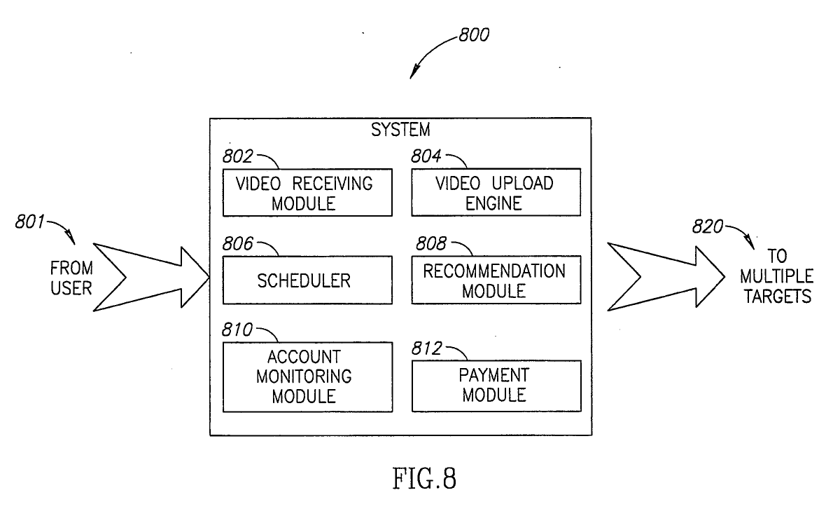

FIG. 8 shows a block diagram of a system (also referred to as a “video upload system”) 800 adapted to receive one or more videos from a user 801 and upload them to a plurality of targets 820, according to an embodiment.

One or more of the forthcoming elements of system 800 may be embodied within a web server or within a plurality of web servers. Persons of skill in the art will recognize that actions performed by the different elements of system 800 may be performed by a single or a plurality of software and/or hardware product(s) running on these server(s) or external to the server(s).

System 800 may include a video receiving module 802 adapted to receive one or more videos from the user and a video upload engine 804 adapted to upload the received video to the plurality of targets 820. The video upload engine 804 may upload the video to targets selected by the user, wherein the user's selection is optionally received by video receiving module 802 and/or by the web server.

Optionally, system 800 may include one or more of the following elements: A scheduler 806 adapted to schedule uploading and removal of the video to and/or from at least one of the targets; a recommendation module 808 adapted to recommend at least one suitable target for upload; an account monitoring module 810 adapted to monitor account information; and a payment module 812 adapted to collect payment from the user.

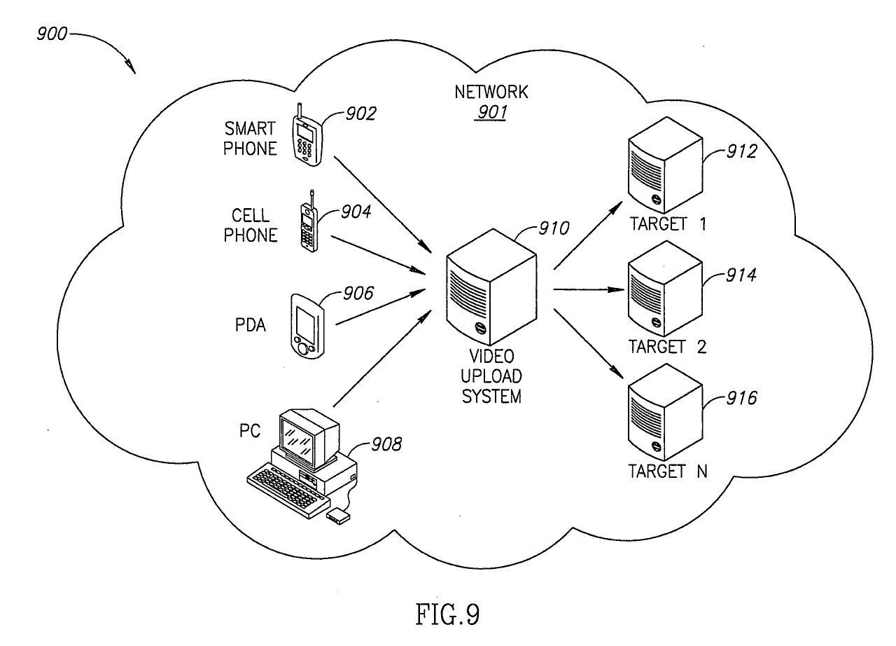

FIG. 9 shows a network diagram 900 of a network 901 enabling interconnection of a user, a video upload system and a plurality of targets. Alternatively, one or more of the elements shown in network diagram 900 may operate in different networks, but in such a way that still enables relay of data where necessary. In some embodiments, network 901 is the Internet.

The user may utilize any type of a computerized device for uploading a video to a video upload system 910. For example, the computerized device may be a smart phone 902, a cell phone 904, a PDA 906, a personal computer (PC) 908 and/or the like. The computerized device may connect to video upload system 910 and upload one or more videos to the -system. Video upload system 910 may then connect to a plurality of targets, such as target 1 912, target 2 914 and target N 916, and for uploading the video to these targets.

While a number of exemplary aspects and embodiments have been discussed above, those of skill in the art will recognize certain modifications, permutations, additions and sub-combinations thereof. It is, therefore, intended that the following appended claims and claims hereafter introduced be interpreted to include all such modifications, permutations, additions and sub-combinations as are within their true spirit: and scope.

In the description and claims of the application, each of the words “comprise” “include” and “have”, and forms thereof, are not necessarily limited to members in a list with which the words may be associated.

What is claimed is:

1. A video upload system comprising:
a web server adapted to receive, from a user, a video file and a selection of a plurality of video sharing websites; and
a video upload engine adapted to log in to said plurality of video sharing websites and to upload said video to said plurality of video sharing websites, based on the selection received from said user.

2. The video upload system according to claim 1, wherein said web server is further adapted to identify the user.

3. The video upload system according to claim 1, wherein said video upload engine is further adapted to select a best performing server of at least one of said plurality of video sharing websites, and wherein said upload is performed to said best performing server.

4. The video upload system according to claim 1, further adapted to fetch statistical information pertaining to said video file from at least one of said plurality of video sharing websites.

5. The video upload system according to claim 1, further adapted to fetch statistical information pertaining to said video file from at least one third-party website embedding said video file.

6. The video upload system according to claim 1, wherein said web server is further adapted to alert said user if said video file is determined to be a previously uploaded video file.

7. The video upload system according to claim 6, wherein said web server is further adapted to prevent the upload of said video file if said video file is determined to be a previously uploaded video file.

8. The video upload system according to claim 1, further comprising a scheduler adapted to schedule said upload of the video file to at least one of said plurality of video sharing websites.

9. The video upload system according to claim 1, further comprising a scheduler adapted to schedule a removal of said video file from at least one of said plurality of video sharing websites.

10. The video upload system according to claim 1, further comprising a recommendation module adapted to provide said user with a recommendation of one or more video sharing websites suitable for the video file.

11. The video upload system according to claim 1, further comprising an account monitoring module adapted to monitor information pertaining to an account of said user.

12. The video upload system according to claim 1, further comprising a payment module adapted to collect payment from said user.

13. The video upload system according to claim 1, wherein said log in comprises a log in using an account selected from a group consisting of: an account registered by said video upload system on behalf of said user, an account registered by said user, and a generic account associated with said video upload system.

14. A method for uploading a video, the method comprising:
receiving, from a user, a video file and a selection of a plurality of video sharing websites;
logging in to the plurality of video sharing websites; and
uploading the video to the plurality of video sharing websites, based on the selection received from the user.

15. The method according to claim 14, further comprising identifying the user.

16. The method according to claim 14, further comprising selecting a best performing server of at least one of the plurality of video sharing websites, and wherein said upload is performed to said best performing server.

17. The method according to claim 14, further comprising fetching statistical information pertaining to the video file from at least one of the plurality of video sharing websites.

18. The method according to claim 14, further comprising fetching statistical information pertaining to said video file from at least one third-party website embedding said video file.

19. The method according to claim 14, further comprising alerting the user if the video file is determined to be a previously uploaded video file.

20. The method according to claim 19, further comprising preventing the upload of the video file if the video file is determined to be a previously uploaded video file.

21. The method according to claim 14, further comprising scheduling the upload of the video file to at least one of the plurality of video sharing websites

22. The method according to claim 14, further comprising scheduling a removal of the video file from at least one of the plurality of video sharing websites.

23. The method according to claim 14, further comprising providing the user with a recommendation of one or more video sharing websites suitable for the video file.

24. The method according to claim 14, further comprising monitoring information pertaining to an account of the user.

25. The method according to claim 14, further comprising collecting payment from the user.

26. The method according to claim 14, wherein the logging in comprises logging in using an account selected from a group consisting of: an account registered by the video upload system on behalf of the user, an account registered by the user, and a generic account associated with the video upload system.
